(19) United States
(12) Patent Application Publication
(10) Pub. No.: US 2025/0363575 A1
(43) Pub. Date: Nov. 27, 2025

(54) METHOD AND SYSTEM FOR VERIFYING AMENDMENTS TO A SET OF DATA

(71) Applicant: XML Ltd., London (GB)

(72) Inventors: Ron GOLAN, London (GB); Yochai LEGUM, London (GB); Nir AGAM, London (GB); Riccardo DI NUZZO, London (GB)

(73) Assignee: XML Ltd., London (GB)

(21) Appl. No.: 18/672,101

(22) Filed: May 23, 2024

(51) Int. Cl. G06Q 50/18; G06F 16/27; G06F 21/60

(52) U.S. Cl. CPC G06Q 50/188; G06F 16/27; G06F 21/602

(57) ABSTRACT

Systems and methods for verifying one or more amendments to a set of data include: processing, in connection with a cryptographically immutable database, an amendment to the set of data to produce an event data item characterizing the amendment; storing the event data item in the cryptographically immutable database as a first stored event data item or as a new stored event data item appended to one or more previously stored event data items; synchronizing all stored event data items to produce a current status of the set of data; and outputting the current status of the set of data on a display.

### FIELD OF THE INVENTION

The present invention relates generally to verifying amendments made to a set of data, in particular amendments made to a contract.

### BACKGROUND OF THE INVENTION

Verifying amendments to a set of data can be important in various fields. For example, in the field of contract negotiation (a contract being a set of data), it can be important that both parties sign the most recent version of a contract, for example a version that incorporates numerous accepted amendments. This can be of particular importance for zero trust parties who may have no direct communication with one another.

Additionally, back and forth communication between the parties on acceptance, rejection, or alteration of amendments can take time, particularly where there is no direct communication between the parties and communications are sent between the parties via a third party as is often the case for Employer of Record (EOR)/Agent of Record (AOR) situations.

Accordingly, there is a need in the art to develop methods and systems to efficiently verify one or more amendments to a set of data.

### SUMMARY

Embodiments of the invention include a method for verifying one or more amendments to a set of data, the method including: processing, by at least one computer processor connected to a cryptographically immutable database, an amendment to the set of data to produce an event data item characterizing the amendment; storing the event data item in the cryptographically immutable database as a first stored event data item or as a new stored event data item appended to one or more previously stored event data items; synchronizing all stored event data items to produce a current status of the set of data; and outputting the current status of the set of data on a display.

According to some embodiments, the cryptographically immutable database is one of: a stream database; or a state transition database.

According to some embodiments, the new stored event data item is stored with a cryptographic relationship to the one or more previously stored event data items.

According to some embodiments, the set of data is a contract.

According to some embodiments, the contract is between at least two zero trust parties.

According to some embodiments, the contract relates to an employer of record (EOR) or agent of record (AOR) contract.

According to some embodiments, the method includes evaluating, by an artificial intelligence (AI) function, the amendment; and either: rejecting, by the AI function, the amendment to the contract; or: accepting, by the AI function, the amendment to the contract; and generating, by the AI function, one or more replacement clauses to the contract based on the amendment, wherein evaluating the amendment and generating the one or more replacement clauses are based on a governing law governing the contract.

According to one or more embodiments of the invention there is provided a system for verifying one or more amendments to a set of data, the system including: at least one computer processor; a cryptographically immutable database; and a memory containing instructions which, when executed by the at least one computer processor, cause the at least one computer processor to: process an amendment to the set of data to produce an event data item characterizing the amendment; store the event data item in the cryptographically immutable database as a first stored event data item or as a new stored event data item appended to one or more previously stored event data items; synchronize all stored event data items to produce a current status of the set of data; and output the current status of the set of data on a display.

According to some embodiments, the cryptographically immutable database is one of: a stream database; or a state transition database.

According to some embodiments, the at least one computer processor is configured to store the new stored event data item with a cryptographic relationship to the one or more previously stored event data items.

According to some embodiments, the set of data is a contract.

According to some embodiments, the contract is between at least two zero trust parties.

According to some embodiments, the contract relates to an employer of record (EOR) or agent of record (AOR) contract.

According to some embodiments, the system includes an artificial intelligence (AI) unit configured to evaluate the amendment; and either: reject the amendment to the contract; or: accept the amendment to the contract; and generate one or more replacement clauses to the contract based on the amendment, wherein the AI unit is configured to evaluate the amendment and generate the one or more replacement clauses based on a governing law governing the contract.

According to one or more embodiments there is provided a method for verifying one or more amendments to a contract, the method including: processing, by a processing function connected to a state transition database, an amendment to the contract to produce an event data item characterizing the amendment; writing the event data item to the state transition database as a first stored event data item or as a new stored event data item appended to one or more previously stored event data items; synchronizing, by a synchronizer function connected to the state transition database, all stored event data items to generate a current version of the contract; and displaying the current version of the contract via a user interface.

According to some embodiments, the new stored event data item includes a cryptographic hash based on the one or more previously stored event data items.

According to some embodiments, the contract is between at least two zero trust parties.

According to some embodiments, the contract relates to an employer of record (EOR) or agent of record (AOR) contract.

According to some embodiments, the method includes evaluating, by an artificial intelligence (AI) function of the user interface, the amendment; and either: rejecting the amendment to the contract; or: accepting the amendment to the contract; and generating, by the AI function, one or more replacement clauses to the contract based on the amendment, wherein evaluating the amendment and generating the one or more replacement clauses are based on a governing law governing the contract.

According to some embodiments, the method includes proposing, by the AI function, based on the amendment to the contract, an alternative amendment to the contract.

### BRIEF DESCRIPTION OF THE DRAWINGS

Non-limiting examples of embodiments of the disclosure are described below with reference to figures attached hereto. The dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 shows a flowchart of a method for verifying one or more amendments to a set of data, according to some embodiments of the invention;

FIG. 2 shows a schematic diagram of an example system for verifying one or more amendments to a set of data, according to some embodiments of the invention;

FIGS. 3A-3D show example photographic views of a user interface, according to some embodiments of the invention;

FIGS. 4A-4D show corresponding line drawing views of the user interfaces depicted in FIGS. 3A-3D;

FIG. 5 shows a flowchart of a method for verifying one or more amendments to a contract, according to some embodiments of the invention; and

FIG. 6 shows a block diagram of an exemplary computing device which may be used with embodiments of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention relate generally to verifying amendments made to a set of data, in particular amendments made to a contract. A contract may be considered a set of data. For example, a contract may be a set of clauses, terms, conditions or the like, containing textual data, dates, monetary amounts (e.g. salary) etc. The clauses, terms, and/or conditions may be enumerated.

In some embodiments, the contract is a smart contract, for example being a computer program or protocol relating to a transaction (such as a transfer of data) which automatically executes according to the terms of the contract.

A contract may be a work contract, such as an employment agreement or contract of employment. The contract may be a work order, service agreement, or other type of contract.

Example use cases of embodiments of the invention include allowing clients to engage workers anywhere worldwide to be legally employed or contracted on the client's behalf, such as in Employer of Record (EOR) and/or Agent of Record (AOR) relationships. Setting up EOR/AOR contracts may be done by a third-party supplier, but getting clients and workers in different countries to agree on the terms of the contract while ensuring compliance with regional laws can be challenging and work intensive. Additionally, creation of work orders, Employment/Service Agreements for EOR/AOR, and onboarding employees can be a complex, labor-intensive, and error-prone process. Embodiments of the invention may allow for clients and workers to negotiate directly in an automated, structured, secure, and compliant way within relevant legal limits and local laws.

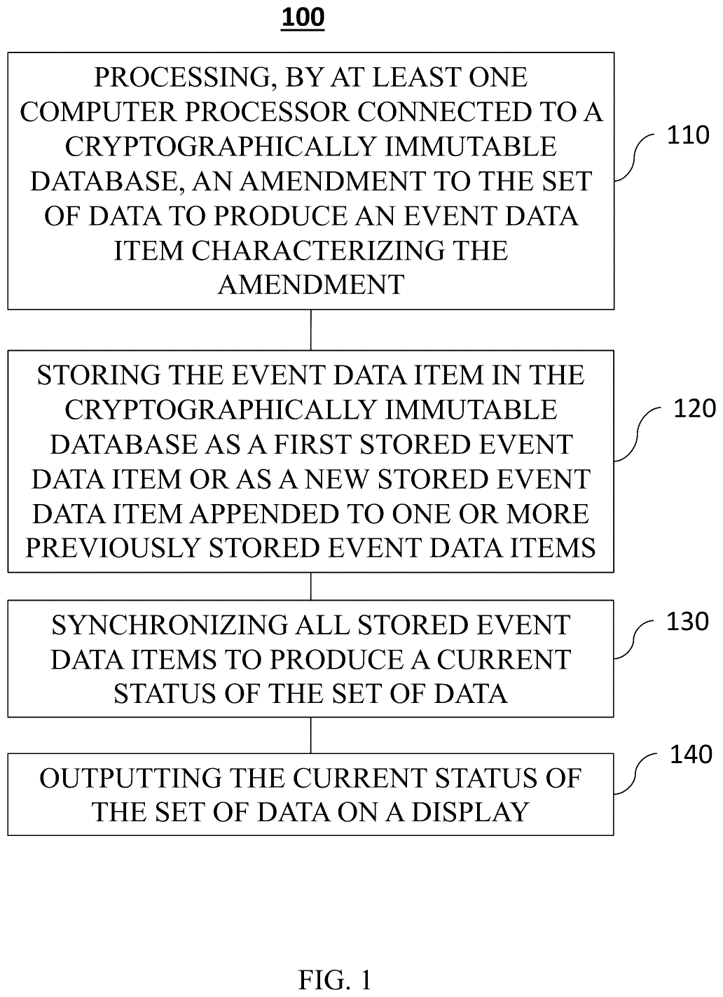

FIG. 1 shows a flowchart of a method 100 for verifying one or more amendments to a set of data, according to some embodiments of the invention. The set of data may be, for example, a contract, such as a smart contract. The contract may be between at least two zero trust parties, for example parties which have no direct communication. The contract may relate to an employer of record (EOR) or agent of record (AOR) contract.

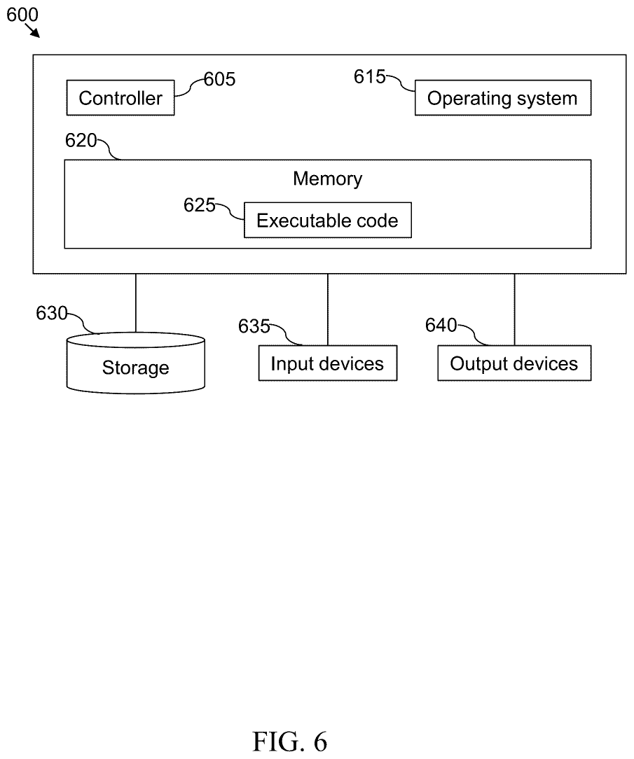

Method 100 may include processing, for example by at least one computer processor connected to a cryptographically immutable database, an amendment to the set of data to produce an event data item characterizing the amendment (Step 110). The at least one computer processor may be, or may include elements of, a computing device 600 as disclosed further herein with respect to FIG. 6.

An event data item may be a piece of data such as a record, list, tuple, or other piece of data. An event data item may characterize an amendment by, for example, identifying the set of data to which the amendment relates, giving a description of the amendment (e.g. if the amendment is a comment the comment may be reproduced), a status of the amendment (e.g. accepted, rejected), a nature of the amendment (e.g. addition, deletion, update), or the like. An event data item may correspond to an event within the field of event driven architecture (EDA).

An amendment may relate to, for example, initial creation or population of the set of data. For example, an initial set of zero elements (an empty set) may be initialized, and data may be added by way of amendment. In the context of contract creation, an amendment may relate to selection of initial contract terms/clauses from a list of applicable terms/clauses, e.g. an initial “empty” contract may be initialized, and a client may amend the empty contract to add the contract terms/clauses which they desire. The amendments may be stored as event data items characterizing the contract terms.

Embodiments of the invention may thus provide a uniform structure in the otherwise unstructured and non-uniform field of contract generation. For example, an initial stage in an embodiment according to the invention may include data collection/population by providing one or more predefined ranges of values or constraints which are selectable by an initiating party initiating the set of data or contract. For example, a skeleton data set or skeleton contract may be presented to an initiating party. Different types of data, such as regional or country-specific data, may be relied upon to set suitable ranges or options within the skeleton contract pertinent to the final (e.g. eventual) contract: e.g. job constraints, such as legal working hours, mandatory probation/notice periods, minimum salary terms, minimum holiday days etc. applicable in the region or country. A predefined structure may then be applied to the skeleton contract and text generated for the clauses constituting the contract, the text generated based on the selected values within the predefined ranges or options. The available values/options within the predefined ranges may be continuously updated and utilized to formulate the main terms of the contract for negotiation. This ensures that both client and worker are selecting values within legal boundaries for the relevant jurisdiction. Once the main terms are agreed upon (e.g. following iterative amendment/negotiation) embodiments of the invention generate the contract according to the defined structure, incorporating relevant legal clauses with parameter values derived from the negotiated main terms.

In some embodiments, the cryptographically immutable database is a stream database and/or state transition database. For example, the cryptographically immutable database may only add entries in a constant stream and not delete entries. For example, entries relating to a rejected amendment may not be deleted: a new event data item may be created which references the event data item produced for the original amendment and marks a status as rejected. By only adding new event data items (e.g. adding events) and not deleting them, a continuous chronological history or ledger is maintained detailing amendments to the set of data. Traceability and verification of amendments may thereby be ensured.

Typically, using a state-transition database can be very challenging since past events cannot be changed. the database architecture according to embodiments of the invention may overcome these problems by not enforcing any rigid structure for the projections and read side, and instead the processing core may be behavior-driven and maintained in the domain functions.

In some embodiments, a database such as provided by Event Store <<https://www.eventstore.com/>> may be utilised.

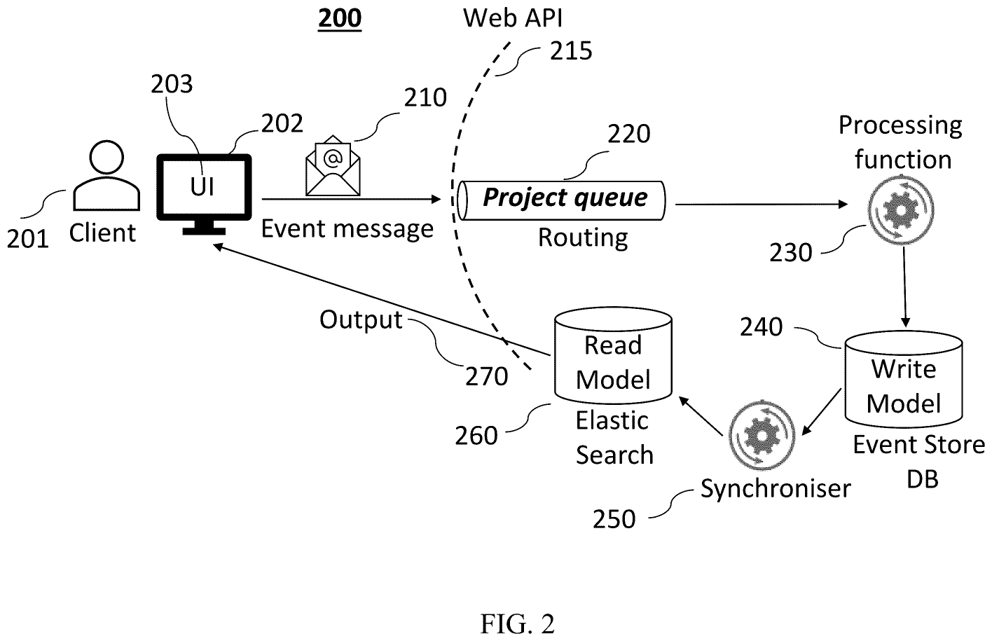

In some embodiments, the adaptation of event messaging for real-time display of contracts involves processing JSON (JavaScript Object Notation) payloads within event messages, which adhere to predefined schemas. Commands within these messages are processed by domain functions based on their bounded context, resulting in the generation of one or more immutable events. These events are appended in a cryptographically immutable database, such as a state-transition database, from which a synchronizer (e.g. synchronizer 250, see FIG. 2) may later retrieve them to create projections for queries and display views.

Method 100 may include storing the event data item in the cryptographically immutable database as a first stored event data item or as a new stored event data item appended to one or more previously stored event data items (Step 120). For example, if the amendment is a first amendment to the set of data, the produced and stored event data item characterizing the amendment may be a first event data item relating to an amendment (e.g. an amendment event) stored in the cryptographically immutable database. Event data items characterizing or otherwise relating to events other than amendments (e.g. creation, signing, completion) may be stored in the cryptographically immutable database.

In some embodiments, stored event data items are stored with a cryptographic relationship to one or more previously stored event data items. For example, the new stored event data item may be stored with a cryptographic relationship to the one or more previously stored event data items. The cryptographic relationship may be, for example, based on a cryptographic hash function. The cryptographic relationship, together with only adding and not deleting event data items, may give rise to the cryptographic immutability of the database in that, for example, a deleted or manipulated entry could be detected due to a missing cryptographic relationship between subsequent new event data items and the existing previously stored event data items.

Method 100 may include synchronizing, for example by a synchronizer function of the at least one computer processor, all stored event data items to produce a current status of the set of data (Step 130). For example, the at least one processor may synchronize a first (e.g. and only) stored event data item, or may synchronize the new stored event data item appended to the one or more previously stored event data items, to produce a current status of the set of data reflective of all event data items (e.g. amendment data items) recorded in respect of the set of data. The synchronization may occur iteratively, for example each time a new event data item is added to the cryptographically immutable database. The synchronization of all stored data items may correspond only to those stored data items for a particular set of data. For example, where the set of data is a contract, only event data items corresponding to amendments to that contract, and not for example other contracts stored in the database which are not of relevance, may be synchronized.

Synchronizing all stored event data items to produce a current status of the set of data may include generating or compiling in a human readable format the set of data. For example, where the set of data is a contract, synchronizing all stored event data items (e.g. amendments to the contract) may include generating a .DOCX or .PDF file of the contract which includes the amended portions. Other file types may be used.

Method 100 may include outputting the current status of the set of data on a display (Step 140). For example, the current status of the set of data may be displayed to a user (such as a worker, or client) on a computer monitor, phone screen, laptop, or other output device (such as output device 640 shown in FIG. 6). The current status of the set of data may be displayed, for example as a .DOCX file, .PDF file, or other image-based format, such as .PNG, .JPEG etc. The current status of the set of data may be displayed as part of a user interface of a dedicated platform (e.g. software platform) for viewing and making amendments to a set of data such as a contract. The platform may be a Software as a Service (SaaS) platform, and may be a cloud based platform.

According to some embodiments, method 100 may include a step of evaluating, by an artificial intelligence (AI) function, the amendment and either rejecting, by the AI function, the amendment to the contract, or accepting, the amendment to the contract.

Rejecting or accepting may be based on one or more predefined criteria for which the AI is entrusted to make a determination. For example, a client may predefine that they permit the AI to automatically reject or accept amendments relating to start and end times and/or working days etc. within a predefined range of values. As another example, a client may predefine that amendments relating to salary or total compensation are to be sent to the client for manual review, e.g. not allowing the AI to automatically accept or reject such amendments. The party proposing the amendment may be informed (e.g. by in-system message of a user interface) that the amendment is rejected pending human review, and the other party may be notified that there is an amendment awaiting review (e.g. by email notification, in-system message of the user interface, or the like).

Accepting the amendment may include proposing by the AI function, based on the amendment to the contract, an alternative amendment to the contract. For example, if the amendment is a request for a higher salary, the AI may be authorized to make a counter-offer within a predefined salary range set by the client.

Accepting the amendment may include generating, for example by the AI function, one or more replacement clauses to the contract based on the amendment. For example, if the amendment relates to a request by a worker for a travel subsidy, e.g. payment by the company of a rail card, the AI may generate a suitable amendment clause for the contract relating to the agreement on the travel subsidy. The AI may be a generative AI such as large language model (LLM).

In some embodiments, the AI function operates using a double-pass flow. For example, in a first pass, the AI function may classify the amendment or comment to understand what sort of change is being requested. Natural language processing (NLP) techniques may be used as part of this classification. In a second pass, a response, such as a human readable response, may be generated using a generative artificial intelligence. The generative artificial intelligence may generate a response based on a prompt which summarizes the classified amendment or comment.

In some embodiments, evaluating the amendment and generating the one or more replacement clauses by the AI function is based on a governing law governing the contract. For example, the AI may be trained on one or more local laws, such as the employment laws of one or more countries or states, so as to evaluate, review or otherwise consider amendments in the context of the law governing the contract. For example, it may not be in accordance with the employment laws of the United Kingdom for a worker to work more than 48 hours a week on average without an applicable exception, and thus if the contract is governed by UK employment law an amendment which would extend the working hours beyond this limit without an applicable exception would be contrary to the law governing the contract: accordingly the AI may reject the amendment. The AI may be trained on relevant exceptions or the like, and may evaluate amendments based on personal or demographic data received from one or more of the parties. Similarly, the AI may be trained to generate, produce, or otherwise create clauses based on an accepted amendment in accordance with a governing law governing the contract. For example, an amendment relating to a request to include in the contract a provision for paternity leave may be generated by the AI in accordance with at least the statutory minimum periods for paternity leave as allowed for by the governing law.

In some embodiments initial contract creation may be governed by a governing law governing the contract. For example, it has been discussed herein that initial contract creation may be considered as one or more amendments to an empty set of data (e.g. a blank contract) and that contract clauses may be selectively added by a client. Each of these additions may represent an amendment. The availability of clauses to include may thus be influenced by the governing law governing the contract. For example, in the U.S. state of California, there are restrictions regarding non-compete and non-solicitation laws: These restrictions may affect both the options available to the client when setting up the contract, and also the legal language which may eventually end up in the generated contract. A non-compete clause may relate to protecting an employer from a worker leaving to join a direct competitor or set up a competing business. A non-solicitation clause may relate to prohibiting a worker from attempting to recruit the employer's staff, customers, and/or suppliers after they stop working for the employer.

As an example, in California, the restrictions may only apply whilst the employee is employed, whereas in New York, the restrictions can continue to apply for a period following the end of employment, such as 6 months, 12 months, 24 months etc.

As an example, as part of initial contract creation according to embodiments of the invention in relation to an employment agreement in California, the client may not have the option to extend the term of the non-compete and non-solicitation clauses: a default option of “while employed” may be presented for selection. In contrast, in relation to an employment agreement in New York, the client may choose between “while employed”, “6 months” or “12 months” terms for a non-compete clause, and/or may choose between “while employed”, “12 months” or “24 months” terms for a non-solicitation clause.

In some embodiments, an AI function or chat bot may assist a client with initial contract creation. For example, using the user interface, a client may select (e.g. checking a box, dragging and dropping, selection from a drop-down list) the initial contract terms. The options may be limited to those allowable and/or applicable according to the governing law governing the contract. The AI function or chat bot may advise on suitable clauses, for example based on the governing law, demographic data of the parties, etc.

FIG. 2 shows a schematic diagram of an example system 200 for verifying one or more amendments to a set of data, according to some embodiments of the invention.

A client 201 may use a computing device 202. Client 201 may be a worker, employee, potential employee, candidate, manager, or any other person. Computing device 202 may be, or may include one or more elements of, a computing device 600 shown in FIG. 6 herein.

Computing device 202 may display a user interface (UI) 203 which may allow client 201 to make one or more amendments to a set of data, such as a contract.

Upon receiving one or more amendments from client 201, computing device 202 running UI 203 may generate an event message 210. Event message 210 may be, for example, a CloudEvent message, being a specification for describing event data in a common way (See, for example, <<https://cloudevents.io>>).

Event message 210 may include, for example: an Id; a Type e.g. the intent of the request; a Source e.g. a certain type of client, a name of a project or a view; a Time e.g. a timestamp of the request; a Data Content Type e.g. application/JSON (JavaScript object notation); a Data Schema e.g. linking a schema for the operation; and/or Data e.g. the specific payload, such as the one or more amendments.

Event message 210 may be sent over web-based API (application programming interface) 215. Event message 210 may be routed to a project queue 220, which may associate event messages with the relevant data sets, e.g. a particular contract. Web API 215 may virtually separate a client-side architecture from an architecture enabling the invention, such as a server-side architecture executed by one or more computing devices.

A processing function 230, such as executed by a computer processor in a computing device, may process event message 210 to produce an event data item characterizing the amendment represented in event message 210. Processing function 230 may include one or more different processing functions, for example: a documenting function for managing documents; a notifying function for managing notifications; an accounting function; a securing function for checking identities; a contracting function e.g. for handling employer of record agreements; a managing function for human resources (HR), expenses, timesheets, and the like; a signing function for signing documents (e.g. with electronic signatures); and/or a ref-data (reference data) function for handling job constraints and pricing, for example storing data for the generation of pre-defined ranges relating to minimum notice periods, maximum working hours, minimum wage/salary, and the like, all of which may be stored per region, state, and/or country.

A write model 240, which may be executed by a computer processor, may write or otherwise store the event data item in a database, such as an Event Store database. The database may be a cryptographically immutable database, such as a stream database or a state transition database. Write model 240 may store the new stored event data item with a cryptographic relationship to one or more previously stored event data items stored in the database. For example, event data items may be stored with a cryptographic hash to other stored event data items.

A synchronizer 250, which may be, for example, a synchronizer function executed by a computer processor, may synchronize all stored event data items stored in the database.

A read model 260, which may be executed by a computer processor, may read one or more event data items from the database, for example using an elastic search. Read model 260 may read stored event data items to produce a current status of the set of data.

The current status of the set of data may be output as an output 270, for example output on a display of client computing device 202, such as displayed on UI 203. The current status of the set of data may incorporate the one or more amendments. For example, the current status of the set of data may be displayed in an image-based format, e.g. in the case of a contract the current status of the contract may be displayed as a .PDF file.

Synchronizer 250 may use pre-existing events, e.g. historic events stored in the database to create a new read model (e.g. a new version), for example to reinterpret old events and provide a focus outside of event specific data. For example, For example, the synchronizer may update a read model view which outputs an EOR summary to the display. If there is a need to add a field to the EOR summary display, then the read model can be updated to include the required field. The synchronizer will update the new read model view without the need to change the immutable events data.

Processing function(s) 230 may use different processing of commands depending on read model version, applicable domain, and/or aggregate. Accordingly, embodiments of the invention may allow for processing of legacy versions, for example sets of data and/or events submitted at an earlier time under an earlier version of the model or structure. Accordingly, synchronizer 250 may recall or otherwise rewrite an applicable read model suitable to read the event versioning of the legacy events. In this way, synchronizer 250 may be able to resurrect or regenerate a deleted read model based on the event versioning alone, and may thus improve the performance of the computing device executing the read model because the read model may not need to be stored, thereby saving computing storage space.

Similarly, whilst synchronizer 250 may synchronize over all stored data, read model 260 may only read data applicable to the view which is to be created, thereby improving the read capabilities of the computing device.

With reference to FIG. 2, an example data flow for the creation of an employer of record (EOR) instance is described below.

The flow starts after client user 201 has entered the required contract details on the application's User Interface 203. This may include the candidate details, job location, type of engagement, start date, and/or salary, and other basic information.

The data entered by client user 201 may be used to create a command CreateEorInstance in accordance with a defined schema and version. The command may be submitted as an event message 210 to project queue 220 for routing to the relevant processing function(s) 230.

Processing function(s) 230 handles the application logic and on completion creates an event. The application logic may change without the need to amend the command schema. The event is stored in database 240 (e.g. a state transition Event Store database). Events may be immutable (e.g. to ensure a single, unchangeable source of truth) and also versioned (to allow execution of older/newer events as the system evolves).

The event created in the state-transition database is processed by Synchroniser 250 which creates Read Model 260.

In this example, the synchronizer handles the event EorInstanceCreatedV3 to create two read model views as output 270: a Client view which includes all the details of the engagement, and a Candidate view which is limited and hides certain details such as client pricing. Both views are created from the same immutable event data. The presentation can be changed easily by amending the read model.

An example command in pseudocode is shown in Table 1 Command

TABLE 1

namespace Remundo.Contracting.Domain.Commands;
public class CreateForInstance : Command
{
public string CorrelationId { get; set; }
public string PriceId { get; set; }
public string EngagementType { get; set; }
public JobLocation JobLocation { get; set; }
public EmployeeDetails EmployeeDetails { get; set; }
public JobDetails JobDetails { get; set; }
public JobSchedule JobSchedule { get; set; }
public StartDateAndSalary StartDateAndSalary { get; set; }
public string OrganisationId { get; set; }
public WorkerContractType? WorkerContractType { get; set; }
public string CreatorId { get; set; }
public bool NonCompeteAvailable { get; set; }
public bool NonSolicitationAvailable { get; set; }
public string TenantId { get; set; }
public IDictionary<string, string> Metadata { get; set; }
}

An example schema in pseudocode is shown in Table 2

### Schema

TABLE 2

```
{
  “$schema”: “https://json-schema.org/draft/2020-12/schema”,
  “type”: “object”,
  “properties”: {
  “CorrelationId”: {
    “type”: “string”,
    “minLength”: 3,
    “maxLength”: 256
  },
  “Status”: {
    “type”: “object”,
    “properties”: {
      “Draft”: {
        “type”: “string”
      },
      “Pending”: {
        “type”: “string”
      },
      “Active”: {
        “type”: “string”
      },
      “Required”: {
        “type”: “string”
      },
      “Deactivated”: {
        “type”: “string”
      }
    },
    “required”: [
      “Draft”,
      “Pending”,
      “Active”,
      “Required”,
      “Deactivated”
    ]
  },
  “OrganisationId”: {
    “type”: “string”,
    “minLength”: 3,
    “maxLength”: 255
  },
  “CreatorId”: {
    “type”: “string”,
    “minLength”: 3,
    “maxLength”: 255
  },
  “PriceId”: {
    “type”: “string”,
    “minLength”: 3,
    “maxLength”: 256
  },
  “EngagementType”: {
    “type”: “string”
  },
  “EmployeeDetails”: {
    “type”: “object”,
    “properties”: {
      “FirstName”: {
        “type”: “string”,
        “minLength”: 1,
        “maxLength”: 256,
        “pattern”: “\hat{ }([a-zA-Z′\\- ]*)$”
      },
      “LastName”: {
        “type”: “string”,
        “minLength”: 1,
        “maxLength”: 256,
        “pattern”: “\hat{ }([a-zA-Z′\\- ]*)$”
      },
      “Email”: {
        “type”: “string”,
        “minLength”: 3,
        “maxLength”: 256,
        “format”: “email”
      },
      “TeamId”: {
        “type”: “string”,
        “minLength”: 3,
        “maxLength”: 256
      }
    },
    “required”: [
      “FirstName”,
      “LastName”,
      “Email”
    ]
  },
  “JobLocation”: {
    “type”: “object”,
    “properties”: {
      “Country”: {
        “type”: “string”
      },
      “City”: {
        “type”: “string”
      },
      “Region”: {
        “type”: [ “string”, “null” ],
        “minLength”: 1,
        “maxLength”: 256
      }
    },
    “required”: [
      “City”,
      “Country”
    ]
  },
“JobDetails”: {
    “type”: “object”,
    “properties”: {
      “Title”: {
        “type”: “string”,
        “minLength”: 1,
        “maxLength”: 256
      },
      “Description”: {
        “type”: “string”
      }
    },
    “required”: [
      “Title”,
      “Description”
    ]
  },
  “JobSchedule”: {
    “type”: “object”,
    “properties”: {
      “WeekSchedule”: {
        “type”: “object”,
        “properties”: {
          “Monday”: {
            “$ref”: “#/$defs/DaySchedule”
          },
          “Tuesday”: {
            “$ref”: “#/$defs/DaySchedule”
          },
          “Wednesday”: {
            “$ref”: “#/$defs/DaySchedule”
          },
          “Thursday”: {
            “$ref”: “#/$defs/DaySchedule”
          },
          “Friday”: {
            “$ref”: “#/$defs/DaySchedule”
          },
          “Saturday”: {
            “$ref”: “#/$defs/DaySchedule”
          },
          “Sunday”: {
            “$ref”: “#/$defs/DaySchedule”
          }
        }
      },
      “TotalWeeklyHours”: {
        “type”: “number”
      },
      “ScheduleType”: {
        “type”: “string”
      }
    },
    “required”: [
      “TotalWeeklyHours”,
      “ScheduleType”
    ]
  },
  “StartDateAndSalary”: {
    “type”: “object”,
    “properties”: {
      “StartDate”: {
        “type”: “string”,
        “format”: “date-time”
      },
      “Salary”: {
        “type”: “number”,
        “minimum”: 1,
        “maximum”: 1000000000
      },
      “BillingEntity”: {
        “type”: “string”,
        “minLength”: 3,
        “maxLength”: 256
      },
    “CurrencyIsoCode”: {
      “type”: “string”,
      “minLength”: 3,
      “maxLength”: 3
    },
    “EndDate”: {
      “type”: [
        “string”,
        “null”
      ],
      “format”: “date-time”
    },
    “Months”: {
      “type”: “number”
    },
    “TimeUnit”: {
      “type”: “string”,
      “minLength”: 1,
      “maxLength”: 50
    },
    “PayRate”: {
      “type”: “number”,
      “minimum”: 1
    }
  },
  “required”: [
    “StartDate”,
    “Salary”,
    “CurrencyIsoCode”
  ]
},
“WorkerContractType”: {
  “type”: “string”,
  “minLength”: 1,
  “maxLength”: 50
},
“NonCompeteAvailable”: {
  “type”: “boolean”
},
“NonSolicitationAvailable”: {
  “type”: “boolean“
},
“TenantId”: {
      “type”: “string”
    }
  },
  “required”: [
    “OrganisationId”,
    “CreatorId”,
    “PriceId”,
    “EmployeeDetails”,
    “JobDetails”,
    “JobSchedule”,
    “StartDateAndSalary”
  ],
  “additionalProperties”: false,
  “$defs”: {
    “DaySchedule”: {
      “type”: “object”,
      “properties”: {
        “Start”: {
          “type”: “string”,
          “pattern”: “(0\\d/1\\d|2[0-3]):[0-5]\\d”
        },
        “End”: {
          “type”: “string”,
          “pattern”: “(0\\d|1\\d|2[0-3]):[0-5]\\d”
        },
        “Duration”: {
          “type”: “number”,
          “minimum”: 0,
          “maximum”: 1440
        }
      },
      “required”: [
        “Start”,
        “End”,
        “Duration”
      ]
    }
  }
}
```

An example event (such as an event message format) is shown in pseudocode in Table 3:

### Event

TABLE 3

```
      namespace Remundo.Contracting.Domain.Events;
      public class ForInstanceCreatedV3 : Event
      {
        public EorInstanceCreatedV3(DateTime startDate, DateTime? endDate, string priceId,
string engagementType, string firstName, string lastName, string email, string teamId,
          string country, string nationalityIsoCode, string city, string? regionIsoCode, string
title,  string  description,  string  currencyIsoCode,  string  schedule TypeTag, string
billingEntityName, string billingEntityId,
          int  holidays,  string  workTypeTag, WeekSchedule? weekSchedule, float
totalWeeklyHours, decimal signingBonusOneOffDataAmount,
          decimal signingBonusVestingDataAmount, int
signingBonusVestingDataCliffMonths, int signingBonusVestingDataTotalMonths,
          decimal variableCompensationSum, bool workPermit, string organisationId, string
creatorId, string workVisaStatus, Coordinates jobLocationCoordinates,
          int?  agreementPeriodMonths,  string?  timeUnit,  decimal?  payRate,
WorkerContractType? workerContractType, string? workerCode, bool? nonCompeteAvailable,
bool? nonSolicitationAvailable,
          IDictionary<string, string> metadata)
        {
          EngagementType = engagementType;
          StartDate = startDate;
          EndDate = endDate;
          PriceId = priceId;
          Country = country;
          City = city;
          RegionIsoCode = regionIsoCode;
          Title = title;
          Description = description;
          CurrencyIsoCode = currencyIsoCode;
          Schedule TypeTag = scheduleTypeTag;
          WorkTypeTag = workTypeTag;
          FirstName = firstName;
          LastName = lastName;
          Email = email;
          TeamId = teamId;
          BillingEntityId = billingEntityId;
          BillingEntityName = billingEntityName;
          WeekSchedule = weekSchedule;
          Metadata = metadata;
          JobLocationCoordinates = jobLocationCoordinates;
          TotalWeeklyHours = totalWeeklyHours;
          SigningBonusOneOffDataAmount = signingBonusOneOffDataAmount;
          SigningBonusVestingDataAmount = signingBonusVestingDataAmount;
          SigningBonusVestingDataCliffMonths = signingBonusVestingDataCliffMonths;
          SigningBonusVestingDataTotalMonths = signingBonusVestingDataTotalMonths;
          VariableCompensationSum = variableCompensationSum;
          Holidays = holidays;
          WorkPermit = workPermit;
          OrganisationId = organisationId;
          CreatorId = creatorId;
          WorkVisaStatus = workVisaStatus;
          NationalityIsoCode = nationalityIsoCode;
          AgreementPeriodMonths = agreementPeriodMonths;
          TimeUnit = time Unit;
          PayRate = payRate;
          WorkerContractType = workerContractType;
          WorkerCode = workerCode;
          NonCompeteAvailable = nonCompeteAvailable;
          NonSolicitationAvailable = nonSolicitationAvailable;
        }
        public string EngagementType { get; }
        public string FirstName { get; }
        public string LastName { get; }
        public string Email { get; }
        public string TeamId { get; }
        public string Country { get; }
        public string City { get; }
        public string? RegionIsoCode { get; }
        public string Title { get; }
        public string NationalityIsoCode { get; }
        public string Description { get; }
        public string CurrencyIsoCode { get; }
        public string ScheduleTypeTag { get; }
        public string BillingEntityName { get; }
        public string BillingEntityId { get; }
        public string WorkTypeTag { get; }
        public WeekSchedule? WeekSchedule { get; }
        public float TotalWeeklyHours { get; }
        public DateTime StartDate { get; }
        public DateTime? EndDate { get; }
        public string PriceId { get; }
        public int Holidays { get; }
        public bool WorkPermit { get; }
        public string OrganisationId { get; }
        public string CreatorId { get; }
        public decimal SigningBonusOneOffDataAmount { get; }
        public decimal SigningBonusVestingDataAmount { get; }
        public int SigningBonusVestingDataCliffMonths { get; }
        public int SigningBonusVestingDataTotalMonths { get; }
        public decimal VariableCompensationSum { get; }
        public string WorkVisaStatus { get; }
        public Coordinates JobLocationCoordinates { get; }
        public int? AgreementPeriodMonths { get; }
        public string? TimeUnit { get; }
        public decimal? PayRate { get; }
        public WorkerContractType? WorkerContractType { get; }
        public string? WorkerCode { get; }
        public bool? NonCompeteAvailable { get; }
        public bool? NonSolicitationAvailable { get; }
        public IDictionary<string, string> Metadata { get; }
      }
```

An example client view coding in pseudocode is shown in Table 4:

### Client View

TABLE 4

```
      namespace Remundo.Synchroniser.EorServicing.Model;
      public enum ForInstanceStatus
      {
        Draft, Pending, Active, Required, Deactivated, Archived, Accepted, Expired,
EorcSigned, ClearancePending, CandidateSignPending,
        CandidateSigned,
        JoiningDocumentsApprovalPending,
        JoiningDocumentsFailed,
        JoiningDocuments Verified,
      }
      public class MainTermsDataModel : IRemundoDocument
      {
        public string FirstName { get; set; }
        public string LastName { get; set; }
        public string LegalFullName { get; set; }
        public string Email { get; set; }
        public string TeamId { get; set; }
        public string Country { get; set; }
        public string City { get; set; }
        public string? RegionIsoCode { get; set; }
        public string Title { get; set; }
        public string Description { get; set; }
        public string CurrencyIsoCode { get; set; }
        public string ScheduleTypeTag { get; set; }
        public string? BillingEntityId { get; set; }
        public string WorkTypeTag { get; set; }
        public float TotalWeeklyHours { get; set; }
        public WeekSchedule? WeekSchedule { get; set; }
        public DateTime StartDate { get; set; }
        public DateTime? EndDate { get; set; }
        public string Id { get; set; }
        public string Source { get; set; }
        public string WorkFromHome { get; set; }
        public string? NonCompete { get; set; }
        public string? NonSolicitation { get; set; }
        public string WorkInParallel { get; set; }
        public DateTime Applies { get; set; }
        public string NationalityIsoCode { get; set; }
        public bool IsWorkPermitRequired { get; set; }
        public bool NonCompeteAvailable { get; set; }
        public bool NonSolicitationAvailable { get; set; }
        public int Holidays { get; set; } = 0;
        public Dictionary<string,  string>  ProposedChanges  {  get;  set;  }  =  new
Dictionary<string, string>( );
        public NoticePeriod NoticePeriods { get; set; }
        public int ProbationPeriod { get; set; } = 0;
        public string ProbationPeriodType { get; set; }
        public string EngagementType { get; set; }
        public decimal VariableCompensationSum { get; set; }
        public string LocalCurrency { get; set; }
        public string ConvertedCurrency { get; set; }
        public string IsoCode { get; set; }
        public string LastSharedEorOperation { get; set; }
        public string LastSharedEorOperationWithCandidate { get; set; }
        public string LastSharedEorOperationWithClient { get; set; }
        public DateTime? DefaultWorkOrderToXmlAdminSentAt { get; set; }
        // Organisation
        public string OrganisationId { get; set; }
        public string OrganisationName { get; set; }
        public string OrganisationCity { get; set; }
        public string OrganisationCountry { get; set; }
        public string? OrganisationRegNum { get; set; }
        public string? OrganisationTaxId { get; set; }
        public string OrganisationAddressLine { get; set; }
        public string OrganisationPostalCode { get; set; }
        public string OrganisationDialCode { get; set; }
        public string? OrganisationPhoneNumber { get; set; }
        public string? OrganisationDunAndBradstreetNo { get; set; }
        [GeoPoint(IgnoreMalformed = true)]
        public Coordinates? OrganisationCoordinates { get; set; }
        [GeoPoint(IgnoreMalformed = true)]
        public Coordinates? JobLocationCoordinates { get; set; }
        [GeoPoint(IgnoreMalformed = true)]
        public Coordinates? CandidateNationalityCoordinates { get; set; }
        public string CreatorId { get; set; }
        public string Status { get; set; }
        public string WorkVisaStatus { get; set; }
        public DateTime? WorkVisaStatusSetToNoAt { get; set; }
        public DateTime LastViewedByCandidate { get; set; }
        public bool HideOnboardingProgress { get; set; }
        public string? CandidateId { get; set; }
        public string? WorkerCode { get; set; }
        public string? AgreementCode { get; set; }
        public string? WorkOrderCode { get; set; }
        public string? GroupCode { get; set; }
        public string? EntityCode { get; set; }
        public bool WorkVisaConfirmedByEorc { get; set; }
        public bool WorkVisaConfirmedByCandidate { get; set; }
        public int? WorkVisaDependentsRequested { get; set; }
        public int? WorkVisaDependentsAccepted { get; set; }
        public bool RemundoSponsorshipSelected { get; set; }
        public bool DependentSponsorshipSelected { get; set; }
        public bool SendLetterToCandidateSelected { get; set; }
        public bool IdVerifiedStage { get; set; }
        public bool AddressVerifiedStage { get; set; }
        public bool ContractSignedStage { get; set; }
        public bool OnboardingDocumentsStage { get; set; }
        public string? WorkerContractType { get; set; }
        public bool NationalityConfirmedByCandidate { get; set; }
        public bool DepositPaid { get; set; }
        public bool DepositCleared { get; set; }
        public string? SigningRequesterId { get; set; }
        public string? SigningRequesteeId { get; set; }
        public DateTime? ContractSignedAt { get; set; }
        public string? SignatoryId { get; set; }
        public  IDictionary<string,  Amendment>  Amendments  {  get;  set;  }  =  new
Dictionary<string, Amendment>( );
        public CountryJobConstraints? SubmittedJC { get; set; }
        public string CountryIsoCode { get; set; }
        public decimal MinimumAnnualSalary { get; set; }
        public string[ ] EligibleNationalitiesIsoCodes { get; set; }
        public int MinimumProbation { get; set; }
        public int MaximumProbation { get; set; }
        public int RegionalStandardProbation { get; set; }
        public int EmployeeMinimumNotice { get; set; }
        public int EmployeeMaximumNotice { get; set; }
        public int EmployeeRegionalStandardNotice { get; set; }
        public int MinimumDaysOff { get; set; }
        public int StandardDaysOff { get; set; }
        public int MaximumDaysOff { get; set; }
        public string DaysOffDisclaimer { get; set; }
        public double PartTimeHolidaysMultiplier { get; set; }
        public int PartTimeTotalHoursLimit { get; set; }
        public int MaxFixedPeriodMonths { get; set; }
        public int? PartTimeMaxFixedPeriodMonths { get; set; }
        public int MaxNumberOfHoursPerWeek { get; set; }
        public int MaxNumberOfHoursPerDay { get; set; }
        public int StandardHoursPerWeek { get; set; }
        public int MaxNumberOfDaysPerWeek { get; set; }
        public string Monday { get; set; }
        public string Tuesday { get; set; }
        public string Wednesday { get; set; }
        public string Thursday { get; set; }
        public string Friday { get; set; }
        public string Saturday { get; set; }
        public string Sunday { get; set; }
        public string? StandardWorkScheduleDisclaimer { get; set; }
        public string ShareEmailDestination { get; set; }
        public string StartDayStandardSchedule { get; set; }
        public string EndDayStandardSchedule { get; set; }
        public string WorkTimeStandardSchedule { get; set; }
        public IDictionary<string, string>[ ] AllowanceTypes { get; set; }
        public bool DisableOpenEnded { get; set; }
        public int EstimatedPrepTimeInBusinessDays { get; set; }
        public int PartTimeMaxHoursPerDay { get; set; }
        public int OrganisationMinimumNotice { get; set; }
        public int OrganisationMaximumNotice { get; set; }
        public int OrganisationRegionalStandardNotice { get; set; }
        public int ProbationMinimumNotice { get; set; }
        public int ProbationMaximumNotice { get; set; }
        public int ProbationRegionalStandardNotice { get; set; }
        public bool WorkVisaDependentSelectable { get; set; }
        public int MinimumContractorAgreementPeriod { get; set; }
        public int MaximumContractorAgreementPeriod { get; set; }
        public decimal MinimumHourlyPayRate { get; set; }
        public decimal MinimumDailyPayRate { get; set; }
        public decimal MinimumMonthlyPayRate { get; set; }
        public int MinimumInitialPeriod { get; set; }
        public int MaximumInitialPeriod { get; set; }
        public int MinimumNoticePeriod { get; set; }
        public int MaximumNoticePeriod { get; set; }
        public int ContractorMinimumNotice { get; set; }
        public int ContractorMaximumNotice { get; set; }
        public int ContractorRegionalStandardNotice { get; set; }
        public IList<BillingEntity> BillingEntities { get; set; } = new List<BillingEntity>( );
        public IList<Comment> Comments { get; set; } = new List<Comment>( );
        public IList<HistoryEvent> History { get; set; } = new List<HistoryEvent>( );
        public string FullWorkOrderCode => GetFullWorkOrderCode( );
        public string GetFullWorkOrderCode( )
        {
        return $“R001/{GroupCode} { (BillingEntityId == null ? “001” :
EntityCode)}/{Country}/{ WorkerCode }/{WorkOrderCode}”;
        }
        public bool IdentityVerification_IdentityVerified { get; set; }
        public bool IdentityVerification_AddressVerified { get; set; }
        public VerificationResult? VerificationStatus { get; set; }
        public string? CustomerId { get; set; }
        public bool FirstSaleCompleted { get; set; }
        public bool TenantArchived { get; set; }
        public decimal AnnualSalary { get; set; }
        public decimal TotalMonthlyGrossSalary { get; set; }
        public IDictionary<string, decimal> GrossSalaryElements { get; set; }
        public IDictionary<string, decimal> MonthlyGrossSalaryElements { get; set; }
        public decimal TotalMonthlyEmployerCosts { get; set; }
        public IDictionary<string, decimal> MonthlyEmployerCostElements { get; set; }
        public IDictionary<string, decimal> EmployerCostElements { get; set; }
        public decimal TotalMonthlyAllowances { get; set; }
        public IDictionary<string, decimal> MonthlyAllowanceElements { get; set; }
        public IDictionary<string, decimal> EmployeePermitFees { get; set; }
        public decimal TotalEmployeePermitFees { get; set; }
        public IDictionary<string, decimal> DependentPermitFees { get; set; }
        public decimal TotalDependentPermitFees { get; set; }
        public IDictionary<string, decimal> DependentInsuranceFees { get; set; }
        public decimal TotalDependentInsuranceFees { get; set; }
        public IDictionary<string, decimal> MonthlyEmployeeInsuranceCosts { get; set; }
        public IDictionary<string, decimal> EmployeeInsuranceCosts { get; set; }
        public decimal TotalMonthlyEmployeeInsuranceCosts { get; set; }
        public IDictionary<string, bool> SelectedInsurances { get; set; }
        public decimal TotalMonthlyTenantCosts { get; set; }
        public IDictionary<string, decimal> MonthlyTenantCosts { get; set; }
        public decimal MonthlyPlatformFee { get; set; }
        public decimal Deposit { get; set; }
        public decimal SigningBonusAmount { get; set; }
        public decimal VestingBonusAmount { get; set; }
        public decimal VestingBonusCliffMonths { get; set; }
        public decimal VestingBonusTotalMonths { get; set; }
        public IDictionary<string, decimal> AdditionalPayments { get; set; }
        public IDictionary<string, decimal> MonthlyExtraCosts { get; set; }
        public decimal TotalMonthlyExtraCosts { get; set; }
        public IDictionary<string, ExtraCost>
        ExtraSections { get; set; } = new
        Dictionary<string, ExtraCost>( );
        public decimal TotalMonthlyCost { get; set; }
        public bool ForInstanceDisconnected { get; set; }
        public bool ManualPriceReturnedToClient { get; set; }
        public string? EmploymentAgreementLink { get; set; }
```

An example candidate view coding in pseudocode is shown in Table 5:

### Candidate View

TABLE 5

```
      namespace Remundo.Synchroniser.EorServicing.Candidate.Model;
      public enum CandidateOnboardingStatus
      {
        Required, Pending, Verified, Rejected
      }
      public enum WorkerContractType
      {
        Employee, Contractor
      }
      public class EorCandidateInstance : IRemundoDocument
      {
        public string Id { get; set; }
        public string PriceId { get; set; }
        public string Source { get; set; }
        public DateTime Applies { get; set; }
        public string FirstName { get; set; }
        public string LastName { get; set; }
        public string LegalFullName { get; set; }
        public string Email { get; set; }
        public string CountryOfEngagement { get; set; }
        public string JobTitle { get; set; }
        public string JobDescription { get; set; }
        public string CurrencyIsoCode { get; set; }
        public string ScheduleTypeTag { get; set; }
        public string OrganisationId { get; set; }
        public string OrganisationName { get; set; }
        public string WorkTypeTag { get; set; }
        public float TotalWeeklyHours { get; set; }
        public WeekSchedule? WeekSchedule { get; set; }
        public DateTime StartDate { get; set; }
        public DateTime? EndDate { get; set; }
        public string WorkFromHome { get; set; }
        public string NationalityIsoCode { get; set; }
        public int Holidays { get; set; } = 0;
        public Dictionary<string, decimal> Allowances { get; set; } = new Dictionary<string,
decimal>( );
        public Dictionary<string, string  ProposedChange    get  set; } = new
Dictionary<string, string>( );
        public NoticePeriod NoticePeriods { get; set; }
        public int ProbationPeriod { get; set; } = 0;
        public decimal SigningBonusOneOffDataAmount { get; set; }
        public decimal SigningBonuVestingDataAmount { get; set; }
        public decimal SigningBonusVestingDataCliffMonths { get; set; }
        public decimal SigningBonusVestingDataTotalMonths { get; set; }
        public decimal VariableCompensationSum { get; set; }
        public decimal GrossSalary { get; set; }
        public string LocalCurrency { get; set; }
        public bool LifeInsurance { get; set; }
        public bool MedicalInsurance { get; set; }
        public bool DisabilityInsurance { get; set; }
        public bool DentalInsuranceSelected { get; set; }
        public bool DeathInsuranceSelected { get; set; }
        public bool IsWorkPermitRequired { get; set; }
        public string WorkVisaStatus { get; set; }
        public EorInstanceStatus Status { get; set; }
        public CandidateOnboardingStatus IdVerificationStatus { get; set; }
        public CandidateOnboardingStatus AddressVerificationStatus { get; set; }
        public CandidateOnboardingStatus DocumentsVerificationStatus { get; set; }
        public string CreatorId { get; set; }
        public string LastSharedOperationWithClientId { get; set; }
        public DateTime? Last ViewedByCandidate { get; set; }
        public DateTime? WorkVisaStatusSetToNoAt { get; set; }
        public bool WorkVisaConfirmedByEorc { get; set; }
        public bool WorkVisaConfirmedByCandidate { get; set; }
        public int? WorkVisaDependentsRequested { get; set; }
        public int? WorkVisaDependentsAccepted { get; set; }
        public bool RemundoSponsorshipSelected { get; set; }
        public bool DependentSponsorshipSelected { get; set; }
        public string? CandidateId { get; set; }
        public int? AgreementPeriodMonths { get; set; }
        public string? TimeUnit { get; set; }
        public decimal? PayRate { get; set; }
        public string? WorkerContractType { get; set; }
        public bool NationalityConfirmedByCandidate { get; set; }
        public VerificationResult? VerificationStatus { get; set; }
        public string? EmploymentAgreementLink { get; set; }
        public string FullAgreementCode { get; set; }
        public IDictionary<string, decimal> PricingFields { get; set; }
        public string? StandardWorkScheduleDisclaimer { get; set; }
        public bool TimesheetsAutomated { get; set; }
      }
```

It will be understood that in Tables 1-5, other coding may be used.

In one or more embodiments, a system for verifying one or more amendments to a set of data includes at least one computer processor, a cryptographically immutable database, and a memory containing instructions which, when executed by the at least one computer processor, cause the at least one computer processor to carry out methods described herein, such as method 100.

For example, the instructions may cause the at least one computer processor to: process an amendment to the set of data to produce an event data item characterizing the amendment; store the event data item in the cryptographically immutable database as a first stored event data item or as a new stored event data item appended to one or more previously stored event data items; synchronize all stored event data items to produce a current status of the set of data; and output the current status of the set of data on a display.

According to some embodiments, the at least one computer processor is configured to store the new stored event data item with a cryptographic relationship to the one or more previously stored event data items. For example, a cryptographic hash may be used.

A system according to some embodiments of the invention, such as system 200, may include an artificial intelligence (AI) unit, which might be, for example, a unit, module, hardware component or software component executed by, coupled to, or otherwise in operative communication with the at least one computer processor.

As described herein, the AI unit may be configured to evaluate an amendment and reject the amendment or accept the amendment. The AI unit may be configured to generate one or more replacement clauses to a contract based on the amendment. The evaluating and the generating may be based on a governing law governing the contract, as described herein.

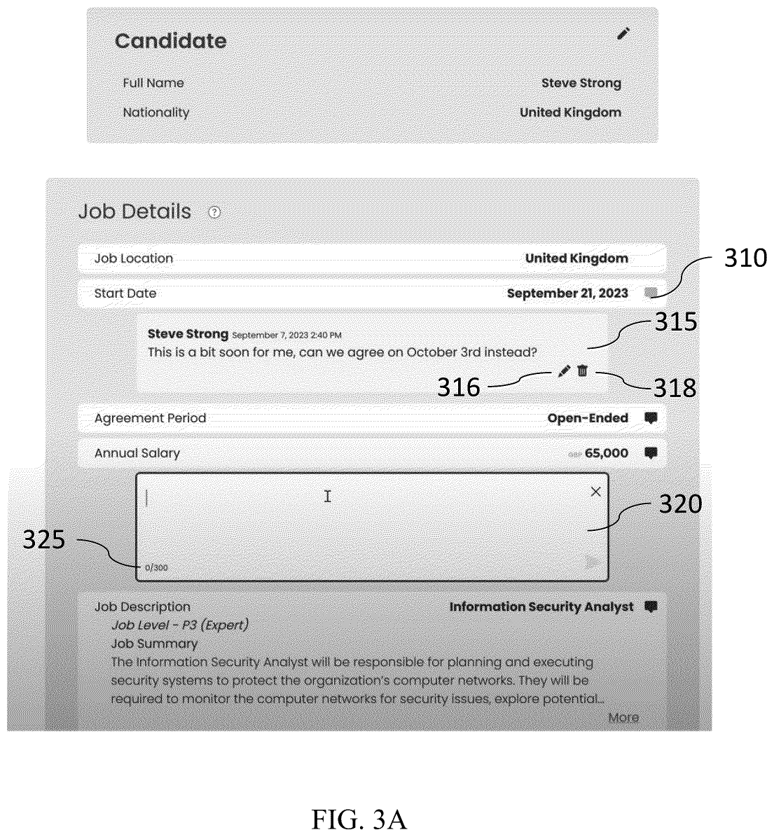

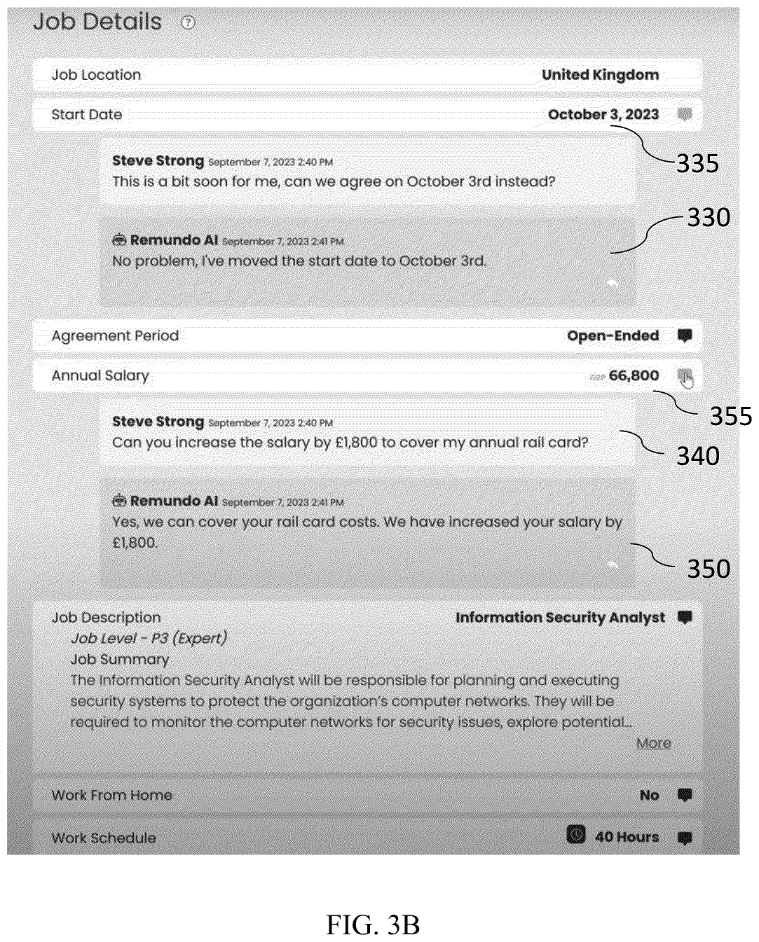

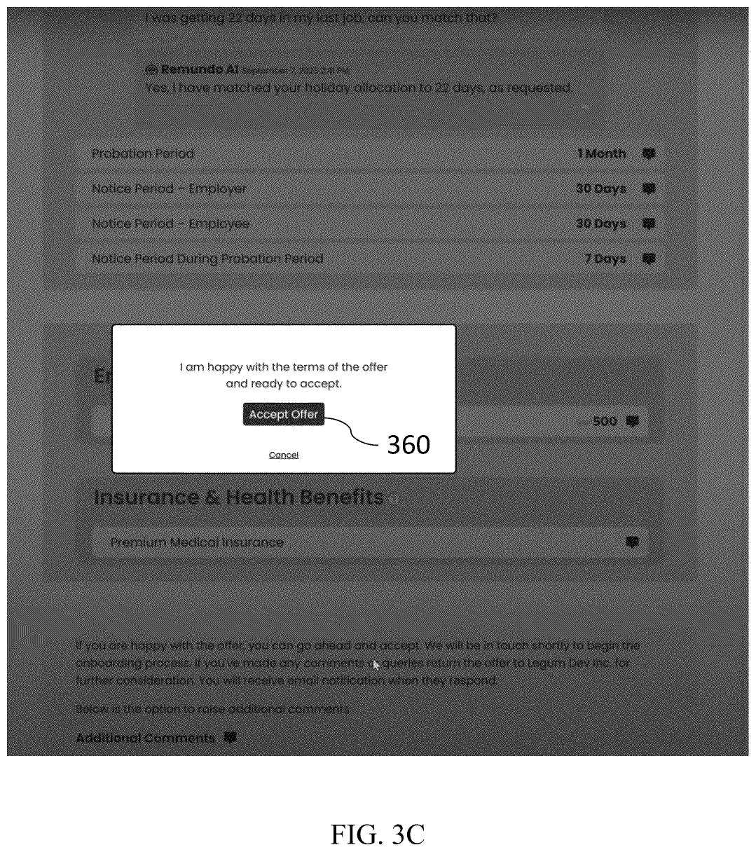

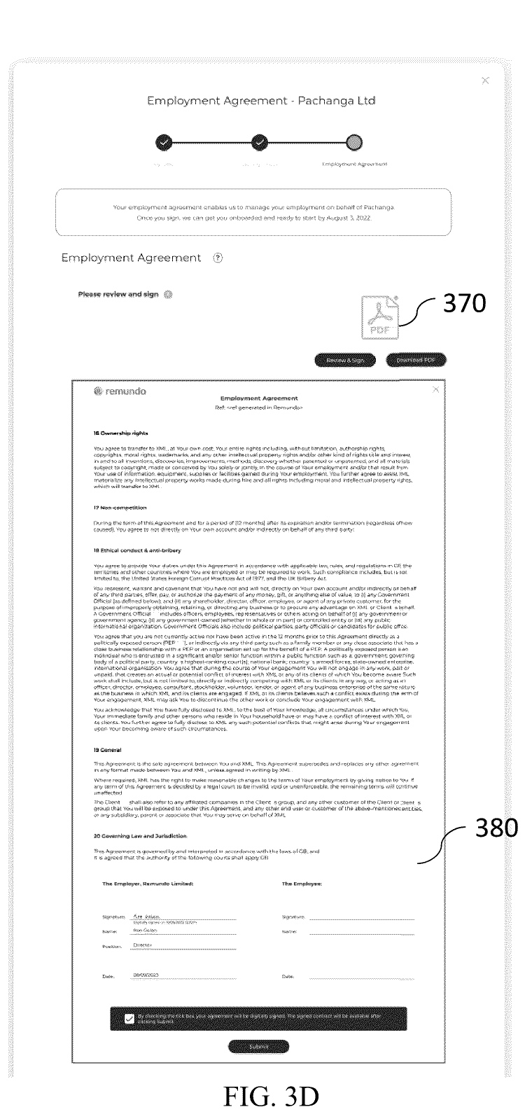

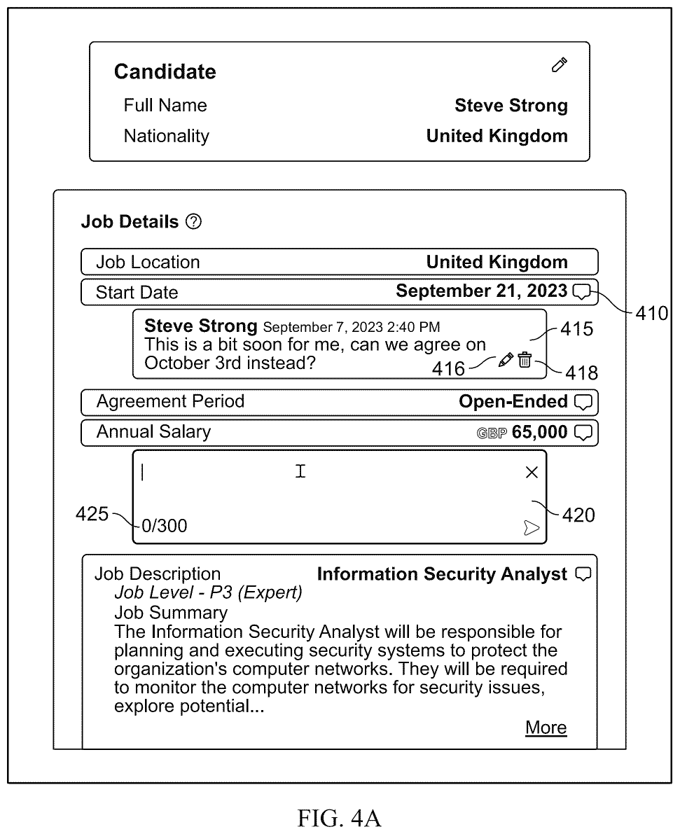

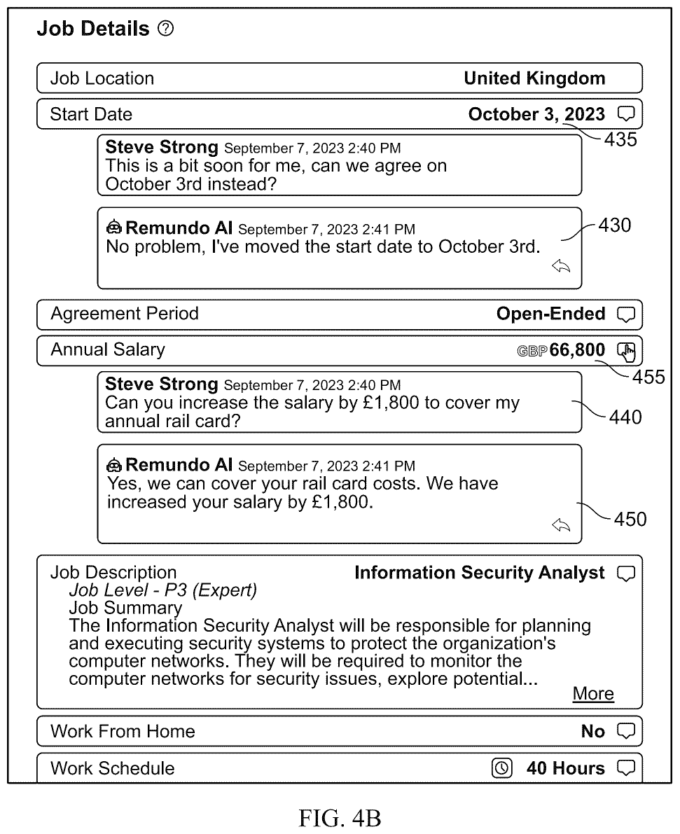

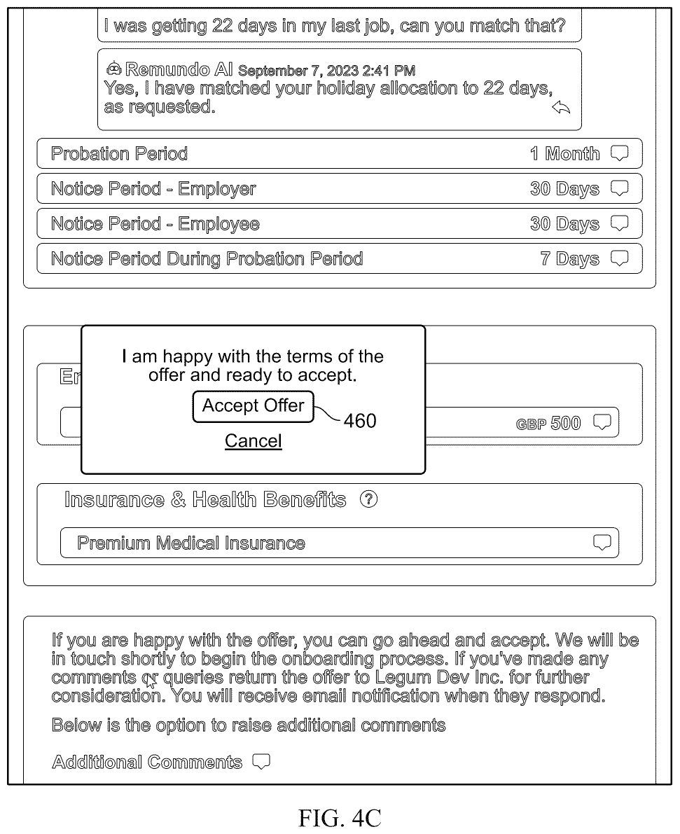

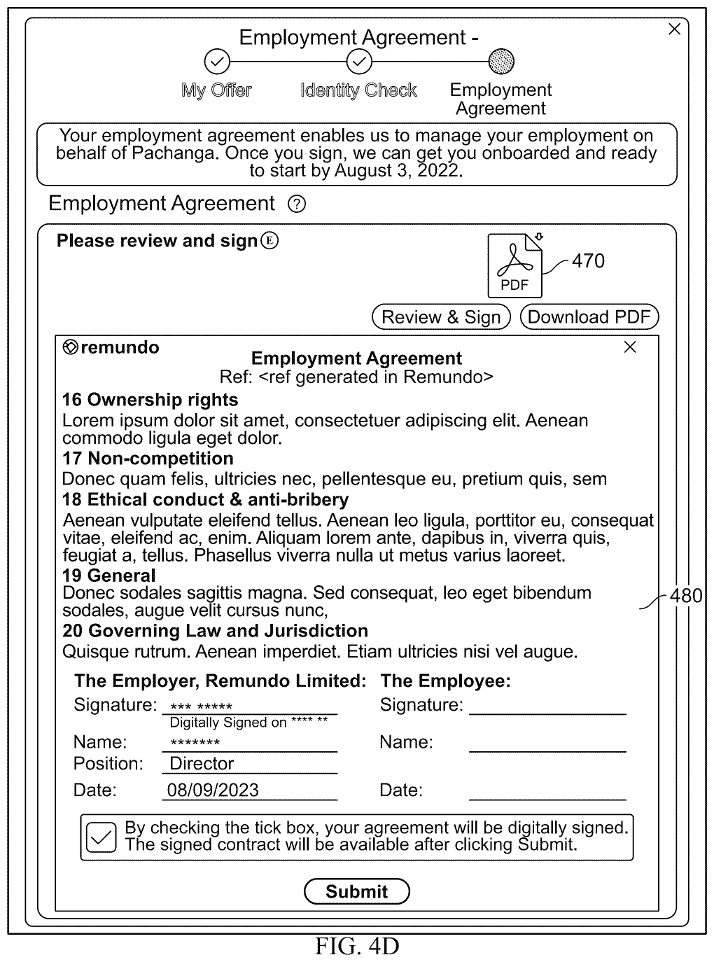

FIGS. 3A-3D show example photographic views of a user interface, according to some embodiments of the invention. FIGS. 4A-4D show corresponding line drawing views of the user interfaces depicted in FIGS. 3A-3D.

In FIGS. 3A/4A, a set of data representing a contract is displayed to a user (such as a worker) via a user interface. For example, the name, nationality, job location, start date, agreement period, annual salary, and job description are shown.

One or more amendments to the set of data can be made by the user, for example using a comment icon 310/410, and leaving a comment with the proposed amendment, such as in submitted comment 315/415. For example, in relation to a start date of Sep. 21, 2023, a user may request a later start date, such as October 3^{rd}, as represented by the proposed amendment in comment 315/415. Amendments/comments may be further edited (316/416) by a user, or deleted (318/418), before being finally submitted. An example empty comment box 320/420 is shown. A comment box may have an associated character limit 325/425, such as 200 characters as shown. Submitted comments/amendments may be sent as an event message and handled by embodiments of the invention as described herein, for example as shown in FIG. 2.

In the view shown in FIGS. 3B/4B, an AI function has reviewed the one or more amendments (e.g. amendment 315/415 shown in FIGS. 3A/4A, and amendment 340/440 shown here) and has accepted the amendments. The AI function may be trained to evaluate amendments in line with a governing law governing the contract, for example here under the governing law of the United Kingdom where the job is located. The acceptance by the AI function is displayed to the user via information boxes 330/430 and 350/450.

For example, the AI function has accepted the amendment 315/415 to start on October 3^{rd}, and has updated the set of data accordingly at 335/435. Additionally, the AI function has accepted the amendment 340/440 to increase the salary to cover an annual rail card, and has updated the set of data accordingly at 355/455. It will be noted on comparison with FIGS. 3A/4A, that the set of data making up the contract has been amended at 335/435 and 355/455. FIGS. 3B/4B thus show the current status of the set of data as resulting of synchronizing stored event data items characterizing the amendments, in accordance with embodiments of the invention.

As shown in FIGS. 3C/4C, the user can accept (360/460) the terms of the contract, e.g. accept the current status of the contract inclusive of one or more accepted amendments.

In FIGS. 3D/4D, the current status 380/480 of the contract may be displayed, for example as a PDF document (370/470). The PDF document may be downloadable, for example for adding a signature, such as an electronic signature or a wet ink signature for scanning.

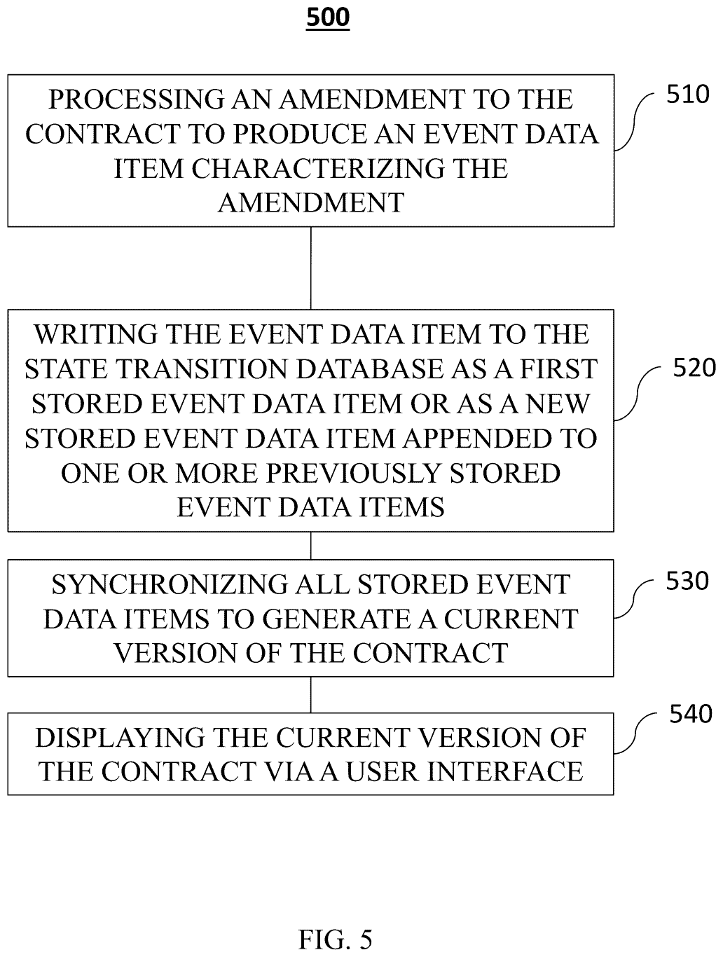

FIG. 5 shows a flowchart of a method 500 for verifying one or more amendments to a contract, according to some embodiments of the invention.

Method 500 may be performed by a computer processor connected to a state transition database. The computer processor may be, or may be part of, a computing device 600 as shown in FIG. 6 herein.

Method 500 may include processing an amendment to the contract to produce an event data item characterizing the amendment (Step 510). The event data item may be as described herein, for example an event data item may characterize an amendment by identifying the set of data to which the amendment relates, giving a description of the amendment (e.g. if the amendment is a comment the comment may be reproduced), a status of the amendment (e.g. accepted, rejected), a nature of the amendment (e.g. addition, deletion, update), or the like.

Method 500 may include writing the event data item to the state transition database as a first stored event data item or as a new stored event data item appended to one or more previously stored event data items (Step 520). For example, entries in the state transition database (such as entries of event data items) may not be deleted, only added in a growing continuous stream of entries. In some embodiments, the new stored event data item includes a cryptographic hash based on the one or more previously stored event data items. This may render the state transition database cryptographically immutable, as described herein.

Method 500 may include synchronizing all stored event data items to generate a current version of the contract (Step 530). For example, all the stored data items relating to the contract may be synchronized to generate a current status of the contract inclusive of the amendments. of The generating may include generating a human readable format of the contract. For example, a .DOCX or .PDF file of the contract which includes the amended portions. Other file types may be used.

Method 500 may include displaying the current version of the contract via a user interface (Step 540). For example, a .DOCX or .PDF file of the contract may be displayed on a user interface. The user interface may be, for example, as described with respect to UI 203, and may include elements of a user interface as described with respect to FIGS. 3A-3D and FIGS. 4A-4D.

In some embodiments, method 500 is performed for a contract between at least two zero trust parties. The contract may relate to an employer of record (EOR) or agent of record (AOR) contract.

In some embodiments, method 500 includes evaluating, by an artificial intelligence (AI) function of the user interface, the amendment. The AI function may reject the amendment to the contract or accept the amendment to the contract. Accepting the amendment may include proposing, by the AI function, based on the amendment to the contract, an alternative amendment to the contract. For example, the AI function may make a counteroffer in a series of negotiations, for example over salary. An allowable range may be defined within which the AI is permitted to propose alternative amendments.

In cases where the AI function accepts the amendment to the contract, the AI function may generate one or more replacement clauses to the contract based on the amendment. The initial evaluating and subsequent generating of one or more replacement clauses may be based on a governing law governing the contract, as described herein.

Reference is now made to FIG. 6, which shows a block diagram of an exemplary computing device 600 which may be used with embodiments of the present invention.

Computing device 600 may include a controller or processor 605 that may be, for example, a central processing unit processor (CPU), a chip or any suitable computing or computational device, an operating system 615, a memory 620, a storage 630, input devices 635 and output devices 640.

Operating system 615 may be or may include any code segment designed and/or configured to perform tasks involving coordination, scheduling, arbitration, supervising, controlling or otherwise managing operation of computing device 600, for example, scheduling execution of programs. Memory 620 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 620 may be or may include a plurality of, possibly different, memory units. Memory 620 may store for example, instructions to carry out a method (e.g., code 625), and/or data. For example the instructions may cause a method such as method 100 or 500 to be performed, as described herein.

Executable code 625 may be any executable code, e.g., an application, a program, a process, task or script. Executable code 625 may be executed by controller 605 possibly under control of operating system 615. In some embodiments, more than one computing device 600 or components of device 600 may be used for multiple functions described herein. For the various modules and functions described herein, one or more computing devices 600 or components of computing device 600 may be used. Devices that include components similar or different to those included in computing device 600 may be used, and may be connected to a network and used as a system. One or more processor(s) 605 may be configured to carry out embodiments of the present invention by, for example, executing software or code. Storage 630 may be or may include, for example, a hard disk drive, a floppy disk drive, a Compact Disk (CD) drive, a CD-Recordable (CD-R) drive, a universal serial bus (USB) device or other suitable removable and/or fixed storage unit. Storage 630 may include cloud-based storage. Storage 630 may include database storage. Storage 630 may be a cryptographically immutable database, such as a stream database or state transition database. In some embodiments, some of the components shown in FIG. 6 may be omitted.

Input devices 635 may be or may include a mouse, a keyboard, a touch screen or pad or any suitable input device. It will be recognized that any suitable number of input devices may be operatively connected to computing device 600 as shown by block 635. Output devices 640 may include one or more displays, speakers and/or any other suitable output devices. It will be recognized that any suitable number of output devices may be operatively connected to computing device 600 as shown by block 640. Any applicable input/output (I/O) devices may be connected to computing device 600, for example, a wired or wireless network interface card (NIC), a modem, printer or facsimile machine, a universal serial bus (USB) device or external hard drive may be included in input devices 635 and/or output devices 640. An output device such as a display may be used to display one or more sets of data, such as a current status of a set of data e.g. a current status of a contract, as described herein.

Embodiments of the invention may include one or more article(s) (e.g., memory 620 or storage 630) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Embodiments of the invention may allow two parties in different countries to reach a settled agreement directly without supplier involvement and produce the correct legal documents in compliance with local laws.

Embodiments of the invention may improve the technologies of process optimization by leveraging event-driven architecture in the inter-personal negotiation process, which may result in improvements in time, efficiency, reduction of errors, and increased automation.

Embodiments of the invention may improve the technologies of data security by increasing trust and verifying that no unauthorized amendments to a set of data have been made by using a cryptographically immutable database to which only entries are added and not deleted, thus creating a continuous and traceable stream of changes. Accuracy of data and prevention of data loss may also be an advantage of the invention.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for verifying one or more amendments to a set of data, the method comprising:
processing, by at least one computer processor connected to a cryptographically immutable database, an amendment to the set of data to produce an event data item characterizing the amendment;
storing the event data item in the cryptographically immutable database as a first stored event data item or as a new stored event data item appended to one or more previously stored event data items;
synchronizing all stored event data items to produce a current status of the set of data; and
outputting the current status of the set of data on a display.

2. The method of claim 1, wherein the cryptographically immutable database is one of: a stream database; or a state transition database.

3. The method of claim 1, wherein the new stored event data item is stored with a cryptographic relationship to the one or more previously stored event data items.

4. The method of claim 1, wherein the set of data is a contract.

5. The method of claim 4, wherein the contract is between at least two zero trust parties.

6. The method of claim 4, wherein the contract relates to an employer of record (EOR) or agent of record (AOR) contract.

7. The method of claim 4, comprising:
evaluating, by an artificial intelligence (AI) function, the amendment; and
either:
rejecting, by the AI function, the amendment to the contract;
or:
accepting, by the AI function, the amendment to the contract; and
generating, by the AI function, one or more replacement clauses to the contract based on the amendment,
wherein evaluating the amendment and generating the one or more replacement clauses are based on a governing law governing the contract.

8. A system for verifying one or more amendments to a set of data, the system comprising:
at least one computer processor;
a cryptographically immutable database; and
a memory containing instructions which, when executed by the at least one computer processor, cause the at least one computer processor to:
process an amendment to the set of data to produce an event data item characterizing the amendment;
store the event data item in the cryptographically immutable database as a first stored event data item or as a new stored event data item appended to one or more previously stored event data items;
synchronize all stored event data items to produce a current status of the set of data; and
output the current status of the set of data on a display.

9. The system of claim 8, wherein the cryptographically immutable database is one of: a stream database; or a state transition database.

10. The system of claim 8, wherein the at least one computer processor is configured to store the new stored event data item with a cryptographic relationship to the one or more previously stored event data items.

11. The system of claim 8, wherein the set of data is a contract.

12. The system of claim 11, wherein the contract is between at least two zero trust parties.

13. The system of claim 11, wherein the contract relates to an employer of record (EOR) or agent of record (AOR) contract.

14. The system of claim 4, comprising an artificial intelligence (AI) unit configured to evaluate the amendment; and
either:
reject the amendment to the contract;
or:
accept the amendment to the contract; and
generate one or more replacement clauses to the contract based on the amendment,
wherein the AI unit is configured to evaluate the amendment and generate the one or more replacement clauses based on a governing law governing the contract.

15. A method for verifying one or more amendments to a contract, the method comprising:
by a computer processor connected to a state transition database:
processing an amendment to the contract to produce an event data item characterizing the amendment;
writing the event data item to the state transition database as a first stored event data item or as a new stored event data item appended to one or more previously stored event data items;
synchronizing all stored event data items to generate a current version of the contract; and
displaying the current version of the contract via a user interface.

16. The method of claim 15, wherein the new stored event data item comprises a cryptographic hash based on the one or more previously stored event data items.

17. The method of claim 15, wherein the contract is between at least two zero trust parties.

18. The method of claim 15, wherein the contract relates to an employer of record (EOR) or agent of record (AOR) contract.

19. The method of claim 15, comprising:
evaluating, by an artificial intelligence (AI) function of the user interface, the amendment; and
either:
rejecting the amendment to the contract;
or:
accepting the amendment to the contract; and
generating, by the AI function, one or more replacement clauses to the contract based on the amendment,
wherein evaluating the amendment and generating the one or more replacement clauses are based on a governing law governing the contract.

20. The method of claim 19, comprising proposing, by the AI function, based on the amendment to the contract, an alternative amendment to the contract.
